(19) United States
(12) Patent Application Publication
(10) Pub. No.: US 2005/0065953 A1
(43) Pub. Date: Mar. 24, 2005

(54) System and method for changing defined elements in a previously compiled program using a description file

(76) Inventors: Shelley K. Bower, Fort Collins, CO (US); Allen J. Miller, Fort Collins, CO (US); Michael W. Roberts, Fort Collins, CO (US); Julie B. Wilson, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/666,705

(22) Filed: Sep. 19, 2003

(51) Int. Cl. G06F 7/00

(52) U.S. Cl. 707/101

(57) ABSTRACT

The invention includes a system and method for changing defined elements in a previously compiled program using a data structure description file without modifying the compiled program. The method can include the operation of loading a data structure description file from a storage location accessible to the compiled program. The data structure description file contains definitions of data structures and is not linked into the compiled program. Another operation is parsing the data structure description file into a configurable filter for the compiled program. The data structure description file can then be validated in the configurable filter. A further operation is defining the compiled program's data structures based on the definitions of the data structures in the data structure description file.

### FIELD OF THE INVENTION

The present invention relates generally to changing defined elements in a previously compiled program using a description file.

### BACKGROUND

A computer software program for a specific hardware platform is generally created by compiling source code written by a software developer into the native assembly language for the hardware. A program's data structures and functionality are generally represented in the source code. In addition, a program interfaces with other programs or the operating system are represented in the source code.

The compiling process creates a loadable executable or multiple executable files that can be used by the computer hardware or host processor. However, it is possible to supply a program that is not in a compiled format using run-time interpretation. Unfortunately, interpreted languages are relatively slow and are not generally used for applications of any significant complexity or for programs that desire any reasonable amount of speed on a given hardware platform. In order to create a faster program for a hardware system, software developers can compile the source code to create an executable image.

A draw back to compiling programs is that any time a change is desired in the program; the source code is changed by a software developer and recompiled. The object code is a fixed image unless a software developer recompiles the program to regenerate the object code files. Whether the desired change is large or small, the source code is modified to reflect the change and then the entire application is recompiled to change the program's object code.

If changes need to be made to the program's data structures or data formats, then changes are made to the source code and the program is recompiled. When changing data formats for a program, the software developer can change the format in at least two places. The first place a change can be made is in the program source code to allow the program to read and manipulate data in the format specified by the software developer. The second place a change can be made is in the data file or database where the actual data is stored. If a program data format or data file changes and the inter-dependent part of the program or data file does not change, then the program can fail because the program is not able to access the data in the expected format. Each time changes are made, the program is recompiled in order to take advantage of the changes.

Not only does recompilation take place when the changes are made to the application or the data structure, but the recompilation is generally performed by an expert software developer who is familiar with the tools for creating the application. Source code changes are preferably performed by someone who knows the program, data details, and rules for the data. In addition, any recompilation is time consuming and may take a few hours or days to provide the appropriate recompilation for an object code image.

Some programs interface with a database that provides for the dynamic entry and removal of data. Even with a database interface, the program must generally be recompiled if there is a change to the database. Any change to database tables that a program accesses will translate into source code changes that are eventually reflected in the compiled program.

A compiled program typically has a fixed set of data structures that are coded into the application and those data structures can store specific types of data. Data is often loaded from a file, database, or some similar storage location into a program. Sometimes program data will come from another program or the operating system. Most frequently, program data is stored on a nonvolatile storage medium regardless of the data source. Each time a program executes, the data can be loaded and manipulated. Then the data may be saved, printed, or other functions can be performed by a user.

If multiple code modules are used during the compilation process, the program will have the references between these multiple modules resolved at linking time. Linking is a process where multiple modules are combined together and any data or code references between those code modules are resolved. Regardless of the object code organization, the data structures and program operations are fixed in an application and the references between separate modules are linked together.

It may appear that some programs can have changes made to them without recompiling the program. For example, many programs have configuration files to control program behavior based on a user's options, settings, or preferences. These configuration files control some behavior in a program, but they are similar to switches that can be turned on or off. A user can change the setting of the software switch in order to enable or disable a function but such configuration flags cannot generally change the program's data formats or behavior. In other words, the program operations are fixed but a user can activate different functions based on the user's preference. All the functionality and data structures for the configuration changes are hard-coded in the application even through certain data settings can vary the operations activated at run time.

An application configuration file includes data that can be loaded into a pre-defined data structure. An example of this is Microsoft Word, which allows a user to control and save toolbar appearance. Despite the fact that the configuration flags can select previously defined functions in the application, the data format read by the program is fixed. The data structures or attributes cannot be modified for the application without recompiling the entire application.

The behavior of a program in relation to its own data structures is not trivial. This is because a defined data structure correlates directly to the program operation and vice versa. In other words, the program maintenance for program functions, data structures, and validation rules is tied together at a fundamental level in the source code. When a data structure is setup, the corresponding source code is created to manipulate that detailed data structure in the appropriate manner. If the source code and final object code do not know the details of the data structure at compile-time, then the program is likely to terminate abnormally (i.e., crash) or produce undesirable output.

### SUMMARY OF THE INVENTION

The invention includes a system and method for changing defined elements in a previously compiled program using a data structure description file without modifying the compiled program. The method can include the operation of loading a data structure description file from a storage location accessible to the compiled program. The data structure description file contains definitions of data structures and is not linked into the compiled program. Another operation is parsing the data structure description file into a configurable filter for the compiled program. The data structure description file can then be validated using the configurable filter. A further operation is defining the compiled program's data structures based on the definitions of the data structures in the data structure description file.

### BRIEF DESCRIPTION OF THE DRAWINGS

FIG. 1 is a flowchart illustrating an embodiment of a method for changing data structures in a previously compiled program using a data structure description file without modifying the compiled program;

FIG. 2 is block diagram depicting an embodiment of a system for changing data structures and validation rules in a previously compiled program using a structure and rules description file, without modifying the compiled program;

FIG. 3 is flow chart illustrating a method of delivering software objects in a computing environment using a compiled software manager with data structures and validation rules that can be modified without re-compiling the software manager;

FIG. 4 is block diagram illustrating an embodiment of system for delivering software objects in a computing environment using a compiled program with data structures and validation rules that can be modified without re-compiling the compiled program; and

FIG. 5 is a block diagram illustrating an embodiment of system for delivering software objects in a computing environment using a compiled program with data structures and validation rules using a configurable input interpreter.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Modifying a computer software program that has been compiled can generally be performed by making changes to the program's source code and recompiling the program. Recompiling a program in order to modify certain aspects of the program after the program has originally been completed is time consuming and involves the services of a skilled software developer.

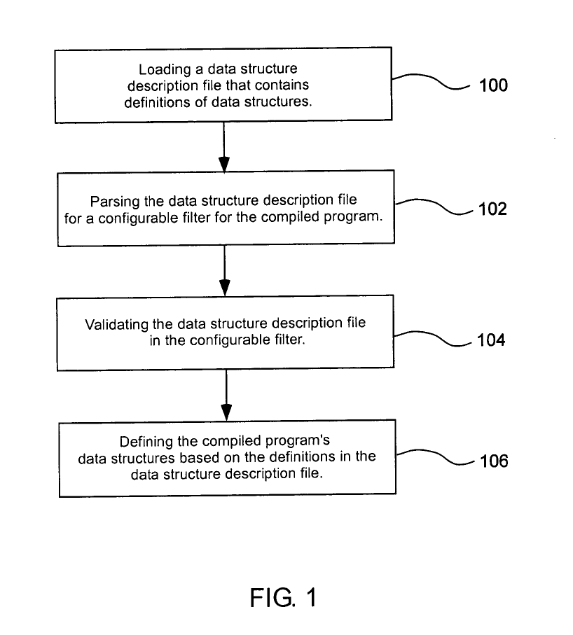

The present invention includes an embodiment of a system and method for changing data structures in a previously compiled program as illustrated in FIG. 1. This modification is performed using a data description file that aids in changing the data structures without modifying the compiled program. The method includes the operation of loading a data structure description file from a storage location that is accessible to the compiled program as in block 100. The data structure description file can be located in a non-volatile storage location such as a hard disk, CD-ROM, magneto-optical disk, network attached storage device, or some other similar storage system. Alternatively, the data structure description file can be loaded from volatile RAM or requested across the network from another computing node.

The data structure description file can contain the definitions of data structures for the program. In addition, the data structure description file is not linked into the compiled program and this is a distinct difference from prior programming practices because data structures are typically linked or compiled directly into the compiled program. This linking takes place whether the data structures are in a separate object code file or are compiled directly into the object code file used as the executable program.

Because the data structure definitions of the present invention are not linked into the compiled program, the data structure definitions can be loaded dynamically by the compiled program. The data structure description file is read using the operation of parsing the data structure description file for a configurable filter associated with the compiled program as in block 102. Parsing identifies the syntactic structure of sentences or strings of symbols in a specified computer language. This language may be in a regular expression language or some other defined language. A parser can take a sequence of tokens generated by a lexical analyzer as input, and a parser may produce some sort of abstract syntax tree as output. The parsing allows the output tokens to be sent to a configurable filter as described.

After parsing, the operation of validating the data structure description file in the configurable filter can be performed as in block 104. The validation operation checks the parsed data structure to ensure that the data meets specific language rules or criteria defined by the specified language the data structure is being created with.

Not only can the data structure be validated dynamically, but the language that the data structure is written and validated in may be provided in a separate file that is loaded into the parser and configurable filter. Being able to change the source language easily provides a more flexible system. Alternatively, the language for creating a data structure can be fixed or hard-coded into the parser and configurable filter. In addition, the data description file can be validated based on the language parameters that are stored within the data structure description file.

Once the data structure description file has been validated, then the compiled program's data structures can be defined based on the definitions of the data structures in the data structure description file as in block 106. In one embodiment, this definition can take place by the instantiation of the data structures within the compiled program's allocated data memory by the compiled program or configurable filter. Alternatively, the compiled program can access these dynamically created data structures in a separate memory location that may be setup by the configurable filter. When the instantiation of the data structure or validation rules takes place, some minimal linking may take place. In one instance, the configurable input filter can send the memory address information of the newly instantiated data structures or validation rules to the compiled program. Of course, if the compiled program has instantiated its own data structures or validation rules using information received from configurable filter, then the compiled program can perform its own internal linking.

Not only can the data structure description file include simply a data structure description, but the description file can also include data structure, attributes, and validation rules which result in a structure and rules description file. Validation rules from the structure and rules description file are used after the program's data structures and validation rules are defined or instantiated in the program. The validation rules allow the program to enforce business rules or data rules as the data structures are manipulated. These validation rules can even include triggers which are actions that will be executed when a defined event occurs. Further, the validation rules can supply error messages or other messages to the user of the compiled program.

The validation rules can check enumerated types to determine if data values are valid or check whether the data values are within a specific value range. A defined type rule can be used to check specific data values to see if they match specified business rules. The validation rules can also be used in the compiled program to verify that the data structures follow specific defined patterns or are regular language expressions. In addition, the validation rules can be used to determine the interdependency of other validation rules. When specific validation rule criteria are met for one rule, then a different validation rule can be applied. More specifically, the validation rules can be used to check if an object has a specific value and determine whether an interdependent validation rule can be applied to the data structure, attribute, or object value.

Help data can also be included in the structure and rules description file. The help information can be tied directly to the data structures and validation rules, which the help descriptions are written to support. This allows the compiled program to load the data structures, attributes, and validation rules and then load the associated help information for each respective component. The modifiable association is important because the data structures, attributes, and validation rules are being loaded dynamically and can change. The compiled program does not know in advance what data structure or validation rules will be received from the description file, and thus the help rules must also be modifiable.

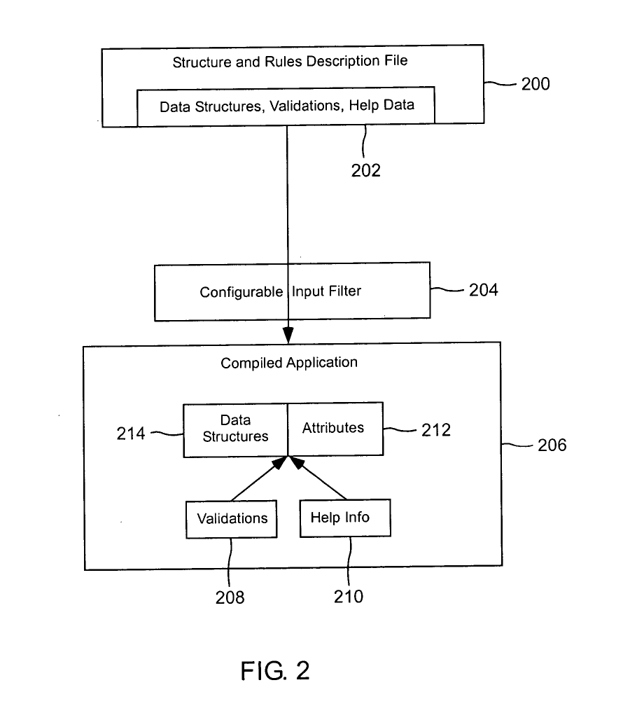

FIG. 2 illustrates a system for changing data structures and validation rules in a previously compiled program using a structure and rules description file. The modification of the data structures and validation rules is performed without recompiling the compiled program. The system includes a structure and rules description file 200 which can contain definitions for data structures and validation rules 202. Data attributes and help information can also be included in the description file.

A configurable input filter 204 is configured to parse and validate the structure and rules description file 200 as the structure and rules description file is read from a storage location. The configurable input filter may include a parser that can recognize a hard-coded syntax or the configurable input filter may load the syntax definition from a separate file. Further, the configurable input filter can be an independent module from the compiled application 206 or a module that is integrated within the compiled application.

The compiled application or program 206 is in communication with the configurable input filter 204. In addition, the compiled program can be configured to instantiate the program's data structures and validation rules based on the definitions received from the structure and rules description file 200. The compiled program will generally know some minimal and/or generic data about the data structure being instantiated such as whether the data structure is a linked list, binary tree, B-tree, list of records, or another type of data structure known to those skilled in the art. This is because the compiled program can perform at least generic operations on the data structures. However, the compiled program does not need to know every detail about the data structures because the validation rules can be used attend to data structure details. The compiled program may alternatively receive a token or message from the configurable input filter to indicate what general type of data structure is being loaded, so that the compiled program will be prepared to operate on that data structure. The compiled program is enabled to instantiate the program's data structures 214 and validation rules 208 based on the definitions received from the structure and rules description file as parsed and validated by the configurable input filter.

Besides the basic data structure and validation rules that are contained in the structure and rules description file 200, the structure and rules description file can supply help information 210 that is related to the data structures, attributes, and validations being used by the compiled application. Since the data structures and validations are dynamic, the help information provided can change for a given version of the data structures or validations. Thus, the help information is linked to the data structures and can change as the data structures, attributes, validations, and other information in the help file change. In addition, help information can be modified as data structures and validations are added or removed.

Attributes 212 for data structures 214 can be included as desired. The attributes for the data structures can include specific details about a data structure, validation, or other object. For example, if there is a data structure that is a container named “fileset” it can have the attribute of a minimum occurrence of one and a maximum occurrence that is limited to one thousand. Thus, the attributes can provide specific data regarding aspects, values, and limitations of similar information for an object.

Because the structure and rules description file is not linked into the program, this design allows the data structures, attributes, validations, business rules, and help information to be independent from the compiled application. As the structure of the data changes or the business rules evolve, the application itself does not have to change. Application maintenance, data maintenance, and validation rule maintenance can be separate and independent activities using the present system and method.

An advantage of separating the described elements from the compiled application is that this separation frees application developers from a significant amount of ongoing application maintenance. Even if the application developers release major revisions periodically, many minor changes can be made to the application data structures, attributes, validation rules, and help data without any intervention from the application developers. Furthermore, the present invention gives application users the ability to make changes that support the user's specific data structure and validation needs.

Another embodiment of the present invention will now be discussed which uses the data structure and validation rules that are independent from the application. A software distributor may desire to introduce a new data model for a software manager. A software manager can generally include tools or applications for creating install packages and images. However, a software manager is not limited to just these functions and may include other software functions. If the data format for the install package creation application is hard-coded into the application, then the application has to be changed or recompiled in order to support the data model change. However, in the present invention, the language syntax and grammar rules are configurable and the data structure can be modified without recompiling the software application. Thus, these changes to the data model can be made without redistributing a new executable for the application.

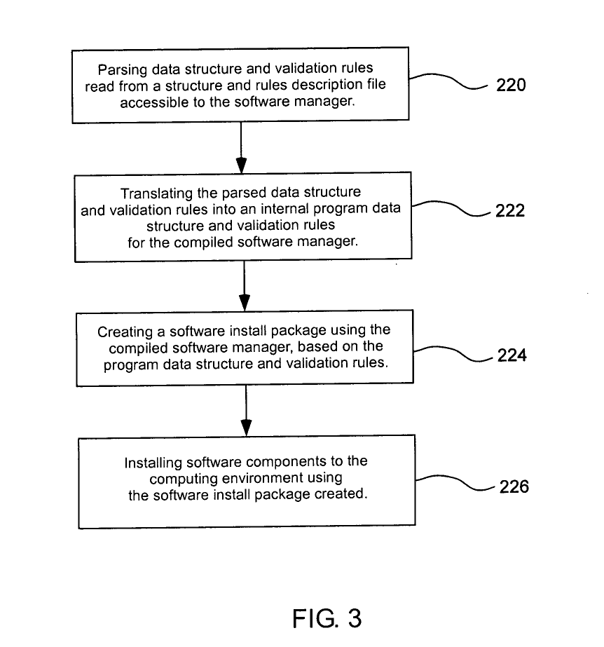

FIG. 3 is a flow chart illustrating a method for this embodiment of the present invention. A method is provided for delivering software objects in a computing environment using a compiled software manager with data structures and validation rules that can be modified without recompiling the software manager. The method includes the operation of parsing the data structure and validation rules read from a structure and rules description file as in block 220. This file can be stored in a storage location which is accessible to the software manager. As mentioned before, the structure and rules description file can be stored on a nonvolatile storage medium such as a hard drive, optical disk, CD, a network attached storage, or some similar nonvolatile storage medium. Alternatively, the file can be read from a memory location where it has been loaded by a host computer. For example, this file can reside in RAM, Flash RAM or a similar type of ROM or RAM.

Another operation is translating the parsed data structure and validation rules into internal program data structure and validation rules for the compiled software manager as in block 222. For example, the data structure may represent an installable software application that has multiple files contained within the application. In addition, the data structure and validation rules can be translated into variables representing packages containing suites of applications as defined by the compiled software manager.

A further operation is creating a software install package or image using the compiled software manager as in block 224. The software install package can have a data structure based on the data structure and validation rules supplied by the structure and rules description file. The software install package may include one or more compressed files that makeup a group of software objects, data files, packages, application suites, bundles, or similar software that can be installed into a computing environment. A final software install package or image is loadable and executable so that the operating system can run the install image and install the appropriate files and components as organized by the software manager. A further operation is installing software components to the computing environment using the software install package created as in block 226.

The structure and validation rules description file helps to enable the incorporation of additional software components that can be installed into the computing environment or operating system. By including additional data structure elements in the structure and rules description file, the structure of the software install package can be modified. For example, defined key words can be added to the structure and rules description file. Defined key words may represent additional files that can be contained in a product definition. Applications may contain multiple file, multiple products, or software bundles within a software install image. For example the data structure or key words can create a tree data structure which defines a software package.

The present invention enables an end user or developer of a software install package to edit the structure and rules description file in order to add, remove, or change defined key word structures, attributes or validation rules. The changes to the key words and data structure can change the structure of the install image that is created by the compiled software manager. Editing can be performed on the structure and rules description file using a text editor if desired. Alternatively, a graphical user interface utility can be provided to edit the structure and rules description file.

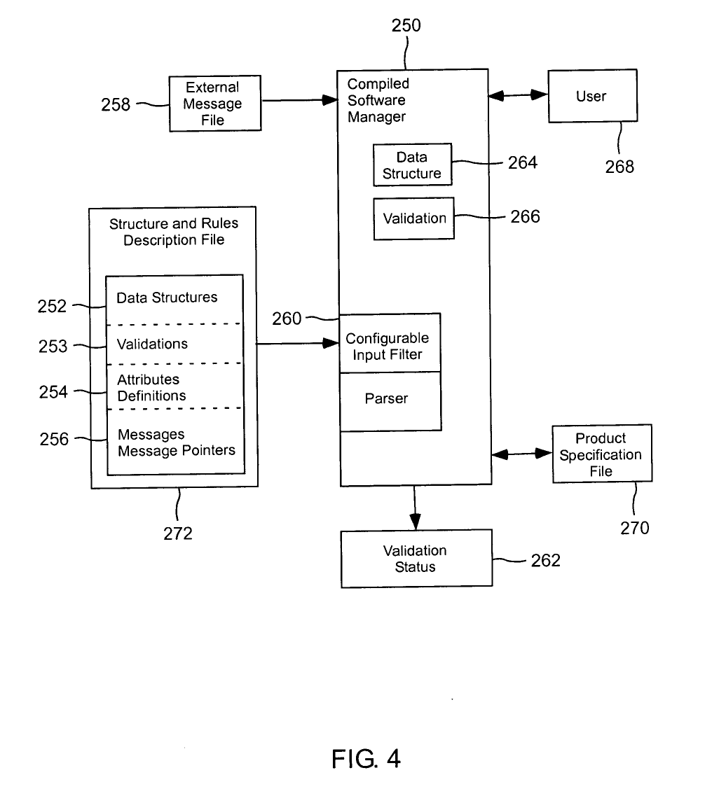

FIG. 4 illustrates a system for delivering software objects in a computing environment or an operating system. The delivery can include installing a software bundle that contains software objects or files. For example, a suite of applications can be installed. The system comprises a structure and rules description file 272 that contains definitions for data structures 252 and validation rules 253. The structure and rules description files are not linked into the compiled software and are therefore independent from the software manager's original compilation process. Attributes and definitions 254 can also be included in the description file. As discussed previously, attributes can be defined for keywords, data structures, objects, or variables. The attributes can store values for a keyword or object such as a maximum, minimum, a string, or an enumerated type for the data structures. However, an attribute is not limited solely to the described types.

Messages or message pointers 256 can be included in the structure and rules description file. The messages can be tied to the data structures, attributes, and validations in the description file. Message pointers may also be provided which point to a separate file or some other location (e.g., universal resource locator (URL) ) so that the messages can be loaded from a location outside of the structure and rules description file.

Some previous software development languages or programs have provided message catalogs that use hard-coded message pointers in the application. In this situation, only the message content can change but not which object, attribute, or validation rule is associated with the message. The present invention allows message pointers or message content to be dynamically associated with different data structures, validation rules, or other dynamic program operations.

Referring again to FIG. 4, a configurable input filter 260 is in communication with the compiled software manager 250. The configurable input filter can parse and validate the structure and rules description file as it is read from a storage location. The parsing that takes place can be integrated directly into the configurable input filter or the parser may be a separate module that is in communication with the configurable input filter, as illustrated in FIG. 4. Alternatively, the configurable input filter and parser may be located separately from the compiled software manager and configured to communicate filtered output to the compiled software manager.

The compiled software manager 250 receives the validated and parsed output from the configurable input filter 260, and the software manager then can instantiate data structures, attributes, and validation rules in the compiled software manager. The dynamically created data structures and validation rules can then be used to generate a product specification file 270. This product specification file can be output from the compiled software manager based on the program data structure 264, validation rules 266, and attributes.

The product specification file 270 can then be used to finally create a software install package for delivery to a user. When the user receives the software install package, the user can load and execute the software install package and the compressed information is uncompressed and installed in the manner defined by the program data structures and validation rules in the compiled software manager.

A particular benefit of the compiled software manager is that it allows a user 268 to create product specification files or software install packages without going through the iterative error correction process that has typically been performed in creating product specification files. In order to understand how to create a specification, the user can read a detailed manual. Then the user edited the product specification file using a text editor and then tried to create an installable software package from the resulting product specification file. Next, the user processed the product specification file and the software to be packaged into a software depot or install image in order to determine whether the product specification file was syntactically correct. If there were errors in the product specification file, then the product specification file would be re-edited by the user who would then re-attempt to create another install image. This trial and error method allowed the user to eventually get enough syntax correct to create a correct image.

With the present invention, a user of the software manager can verify that the product specification file is syntactically correct without creating an actual install image. Users receive immediate feedback about their installation project because the software manager limits the user's choices to legal structures based on the provided syntax and language in the external structure and rules description file.

The validation rules 266 can check for the appropriate data structures and data values according to the defined rules. This means that a user 268 can immediately see when an error has been generated or some conflict may exist because a message can be displayed in a window or graphical user interface control. For example, as the errors are identified via the validation rules, the validation status 262 of the data structure and values can be output in a window, a drop down list, or some other graphical user interface output. In addition to validations, there can be an external message file 258 which contains messages referred to by the message pointers 256.

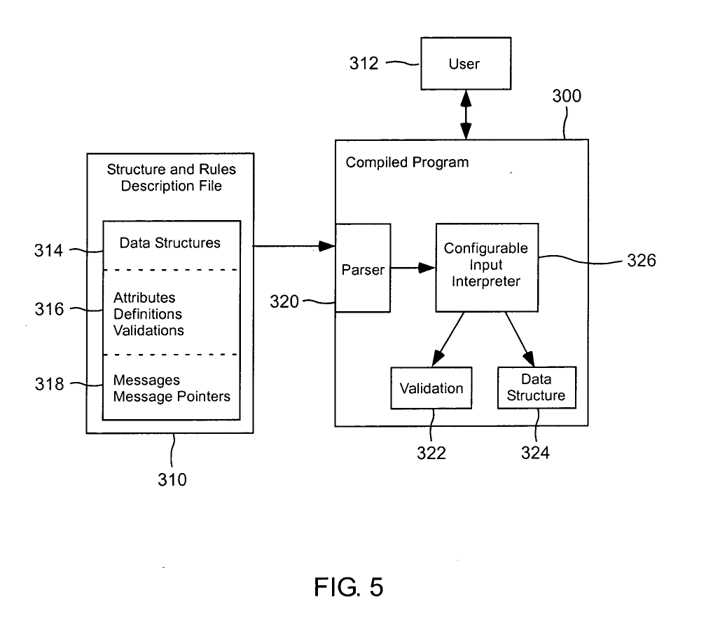

FIG. 5 illustrates an additional embodiment of a system for supplying data structures and validation rules in a previously compiled program using a structure and rules description file with interpretive loading of the structure and rules description file. The system includes a structure and rules description file 310 containing definitions for data structures 314, validation rules 316, attributes, definitions, messages and message pointers 318. The description file can be loaded by a parser 320 that is configured to parse the structure and rules description file as the structure and rules description file is read from a storage location.

A configurable input interpreter 326 can be located with or in the compiled program. The parser is in communication with the configurable input interpreter and can send parsed data to the configurable input interpreter. In addition, the configurable input interpreter can be configured to interpret the structure and rules description file when the compiled program is executing. The previous embodiments discussed are directed generally toward, but are not limited to, loading the structure and rules description file when the compiled application is loaded for execution. However, in the present embodiment, the configurable input interpreter can load and create new data structures 324, attributes, validations 322 and any other information at the request of the user 312 or the compiled program 300. For example, the execution time loading can be activated by clicking a button in the compiled program or the compiled program can be pre-programmed to load information at specific points during the program's execution.

Not only can the information structure and rules description file be loaded at execution time or run-time but the interpreter may generate additional object code to manipulate the data structures. This object code can be created based on the validations supplied by the description file or object code can be generated based on the types of data structures, attributes, validations and similar structures loaded. In addition, object code can be based on other pseudo source code instructions or explicit source instructions included in the description file. A user interface can also be provided in the compiled program that is configured to enable access to the data structures and validation rules.

In another embodiment of the present invention, the system and method can use XML (Extensible Markup Language) files for the structure and rules description file. XML is a useful format because it provides objects, structures, and attributes that can be considered self-defining and sub-objects can also be contained within an object. In addition, XML can be used to define objects that are validation rules, business rules, or help messages.

The Document Object Model (DOM) may be used to create an interface for the compiled program and scripts to dynamically access the structure and rules description file. Particularly, DOM is a platform and language interface that allows programs and scripts to dynamically access and update the content of documents. DOM provides a standard from an international standards committee for the random access of XML data.

In the case of a software manager, changes to an external XML file can control many aspects of the programs behavior. Specifically, the XML file can control the software package structure and policies for acceptable attribute values. Help can also be included for understanding the software packaging policies as defined by the XML file. The XML file can also control the validation of the package specifications against packaging policies. A user can change anything that the external XML files control without changing the program source code or recompiling the software manager. For example, users can define company specific packaging and installation policies or even extend the software manager to support other packaging formats that were not known when the software manager was originally created.

The present invention provides advantages over past computer software programs because application behavior has generally been hard-coded within the application. Changes to the data format and business rules have typically needed source code changes and program recompilation. In contrast, the present invention allows users or developers to significantly change the data structures and some behavior for an application without changing the source code or recompiling the application. When the data structure design for a program changes, then the XML file can be modified and the application can learn about the new data objects and formats when the program loads the XML description files.

If the business rules which drive the application change, the application itself does not need to be recompiled. Changes to the XML structure and rules description file can dynamically control many aspects of the application's behavior and the software manager or application can load the business rules when the program first executes. Moreover, modifiable rules allow users of the application to modify the application's behavior to better support changing user needs. Users have the potential to change anything that the external structure and rules description file controls.

One result of the improved responsiveness of the software manager is that users receive feedback earlier in the software installation package creation process. Accordingly, generating the installation package is less time consuming and more reliable. Another benefit of the flexible software manager is that users who need to create an installable image do not need the completed software application. The packaging specification can be constructed and validated before the application is ready to be compressed and packaged. This is because the software manager can validate the packaging specification without actually generating an installation package.

Not only do users receive feedback about syntax and grammar but the users also receive business rule feedback about the conformity or non-conformity of software package attributes. Online help policies can be viewed in conjunction with specific objects to provide direct help to the user with respect to creating and correcting software objects. In addition, the validation errors are immediately reported and can be fixed without attempting to create the entire software install package and having that creation fail prematurely.

In contrast, individuals who have used previous software packaging or install solutions have had an extensive knowledge of package specification syntax, rules regarding valid values, and company specific software packaging or installation policies. Problems with syntax and valid data values could not frequently be identified until the software installation file or image was created. Company specific policies were difficult to verify until software tools even further along in the process of creating and testing the package later validated the software installation packages or images.

The process of creating software installation packages has generally been regarded as so complex that few end users have chosen to use the native software install format in some versions of UNIX. Rather, many software developers have simply used compression programs such as “tar” and “ninstall” which do not register the software in the installed product database in the operating system. The present invention overcomes this problem and provides a robust and powerful solution for creating install images.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

1. A method for changing defined elements in a previously compiled program using a data structure description file without modifying the compiled program, comprising the steps of:
loading a data structure description file from a storage location accessible to the compiled program, wherein the data structure description file contains definitions of data structures and is not linked into the compiled program;
parsing the data structure description file for a configurable filter in communication with the compiled program;
validating the data structure description file using the configurable filter; and
defining the compiled program's data structures based on the definitions of the data structures in the data structure description file.

2. A method as in claim 1, wherein the step of validating the data structure description file further comprises the step of validating the data description file based on language parameters loaded from the data structure description file.

3. A method for changing data structures and validation rules in a previously compiled program using a structure and rules description file without modifying the compiled program, comprising the steps of:
loading a structure and rules description file that contains definitions of data structures and validation rules from a storage location accessible to the compiled program, wherein the structure and rules description file is not linked into the compiled program; and
parsing the structure and rules description file into a configurable filter in the compiled program;
validating the structure and rules description file in the configurable filter; and
defining the compiled program's data structures and validation rules based on the definitions in the structure and rules description file.

4. A method as in claim 3, further comprising the step of supplying help files related to the data structure and validation rules using help information stored in the structure and rules description file.

5. A method as in claim 3, further comprising the step of applying validation rules within the compiled program in order to check data values.

6. A method as in claim 5, further comprising the step of applying the validation rules in the compiled program to provide enumerated values for data values.

7. A method as in claim 5, further comprising the step of applying validation rules in the compiled program to verify that data structures follow a pattern as defined by a regular expression.

8. A method as in claim 5, further comprising the step of applying validation rules in the compiled program to determine the interdependency of validation rules.

9. A method as in claim 8, further comprising the step of applying interdependent validation rules based on an object's value.

10. A method as in claim 3, wherein the step of validating the structure and rules description file further comprises the step of validating the structure and rules description file against a configurable filter that includes defined keywords, data structures, and a validation language.

11. A system for changing data structures and validation rules in a previously compiled program using a structure and rules description file, without modifying the compiled program, comprising:
a structure and rules description file containing definitions for data structures and validation rules, wherein the structure and rules description file is not linked into the compiled program;
a configurable input filter enabled to parse and validate the structure and rules description file as the structure and rules description file is read from a storage location; and
wherein the compiled program is in communication with the configurable input filter, the compiled program being configured to instantiate the program's data structures and validation rules based on the definitions received from the structure and rules description file.

12. A system as in claim 11, further comprising a user interface in the compiled program that is configured to enable access to the data structures and validation rules.

13. A system as in claim 11, further comprising a validation status module to report the validation status for data structures and validation rules in the compiled program.

14. A system as in claim 11, further comprising a help system module configured to provide help information about the data structures and validation rules.

15. A system as in claim 11, wherein the structure and rules description file further comprises data attributes.

16. A method of delivering software objects in a computing environment using a compiled software manager with data structures and validation rules that can be modified without re-compiling the software manager, comprising the steps of:
parsing data structure and validation rules read from a structure and rules description file located in a storage location accessible to the software manager;
translating the parsed data structure and validation rules into an internal program data structure and validation rules for the compiled software manager; and
creating a software install image using the compiled software manager, based on the program data structure and validation rules.

17. A method as in claim 16, further comprising the step of installing software components to the computing environment using the software install image created.

18. A method as in claim 16, further comprising the step of enabling additional software components to be installed into the computing environment by including additional data structure elements in the structure and rules description file.

19. A method as in claim 16, further comprising the step of using defined keywords in the structure and rules description file.

20. A method as in claim 19, further comprising the step of adding defined keywords to the data structure as included in the structure and rules description file.

21. A method as in claim 16, further comprising the step of editing the structure and rules description file using a text editor to change the data structure and validation rules in the structure and rules description file.

22. A method as in claim 16, further comprising the step of including help information related to the data structure and validation rules in a separate help file.

23. A method as in claim 21, further comprising the step of providing access to the help information for the data structure and validation rules via the compiled program.

24. A system for delivering software objects in a computing environment using data structures and validation rules that can be modified without recompilation, comprising:
a structure and rules description file containing definitions for data structures and validation rules, wherein the structure and rules description file is not linked into the compiled software manager;
a configurable input filter that is configured to parse and validate the structure and rules description file as the structure and rules description file is read from a storage location;
a compiled software manager in communication with the configurable input filter, the compiled software manager being configured to instantiate data structures and validation rules in the compiled software manager based on the definitions received from the structure and rules description file; and
a product specification file generated from the compiled software manager, based on the program data structure and validation rules.

25. A system for delivering software objects as in claim 24, further comprising a software install image generated by the compiled software manager using the product specification file.

26. A system for supplying data structures and validation rules in a previously compiled program using a structure and rules description file, without modifying the compiled program, comprising:
a structure and rules description file containing definitions for data structures and validation rules, wherein the structure and rules description file is not linked into the compiled program;
a parser configured to parse the structure and rules description file as the structure and rules description file is read from a storage location; and
a configurable input interpreter in the compiled program and in communication with the parser, the configurable input interpreter being configured to interpret the structure and rules description file when the compiled program is executing and configured to instantiate the program's data structures and validation rules based on the definitions received from the structure and rules description file.

27. A system as in claim 26, further comprising instantiated data structures and object code to manipulate the data structures, the object code being created by the configurable input interpreter from the definitions received from the structure and rules description file.

28. A system as in claim 26, further comprising a user interface in the compiled program that is configured to enable access to the data structures and validation rules.

29. A system for changing data structures and validation rules in a previously compiled program using a structure and rules description file, without modifying the compiled program, comprising:
a structure and rules description means for containing definitions for data structures and validation rules, wherein the structure and rules description means is not linked into the compiled program;
a configurable input means for parsing and validating the structure and rules description means as the structure and rules description means is read from a storage location;
wherein the compiled program is in communication with the configurable input means, the compiled program being configured to instantiate the program's data structures and validation rules based on the definitions received from the structure and rules description means; and
a user interface means in the compiled program that is configured to enable access to the data structures and validation rules.

30. An article of manufacture, comprising: a computer usable medium having computer readable program code means embodied therein for changing defined elements in a previously compiled program using a data structure description file without modifying the compiled program, the computer readable program code means in the article of manufacture comprising:
computer readable program code means for loading a data structure description file from a storage location accessible to the compiled program, wherein the data structure description file contains definitions of data structures and is not linked into the compiled program;
computer readable program code means for parsing the data structure description file for a configurable filter in communication with the compiled program;
computer readable program code means for validating the data structure description file using the configurable filter; and
computer readable program code means for defining the compiled program's data structures based on the definitions of the data structures in the data structure description file.
